(19) United States
(12) Patent Application Publication
(10) Pub. No.: US 2021/0323244 A1
(43) Pub. Date: Oct. 21, 2021

(54) MACHINE FOR FITTING PIPE AND COMPONENTS TOGETHER

(71) Applicant: Kevin Price, Arlington, TX (US)

(72) Inventor: Kevin Price, Arlington, TX (US)

(21) Appl. No.: 16/846,179

(22) Filed: Apr. 10, 2020

Related U.S. Application Data
(60) Provisional application No. 62/831,945, filed on Apr. 10, 2019.

(51) Int. Cl. B29C 65/00

(52) U.S. Cl. CPC B29C 66/83511; B29C 66/8169; B29C 66/81417; B29C 66/5221

(57) ABSTRACT

A machine for fitting pipe and components together that has a traveling beam that rolls over a support structure. Various clamps, vices and other devices to hold pipes and fittings are attached to the beam or other parts of the support structure. Motion could be in any direction so as to algin pipes or fittings to be in position to be joined together.

### BACKGROUND

### Field of the Invention

The present invention relates generally to devices and machines for connecting components, such as pipes, together, and more specifically to a machine that is configured to aid in fitting pipes and components together and hold them square and level so that they can be tacked together for welding. The system of the present invention is versatile and efficient and can be scaled up for large projects.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified top view of a machine in accordance with the present invention;

FIG. 2 is an end view of a centering vise of FIG. 1;

FIG. 3 is a side view of a carriage of FIG. 1; and

FIG. 4 is a flowchart of a method of use of the machine of FIG. 1.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

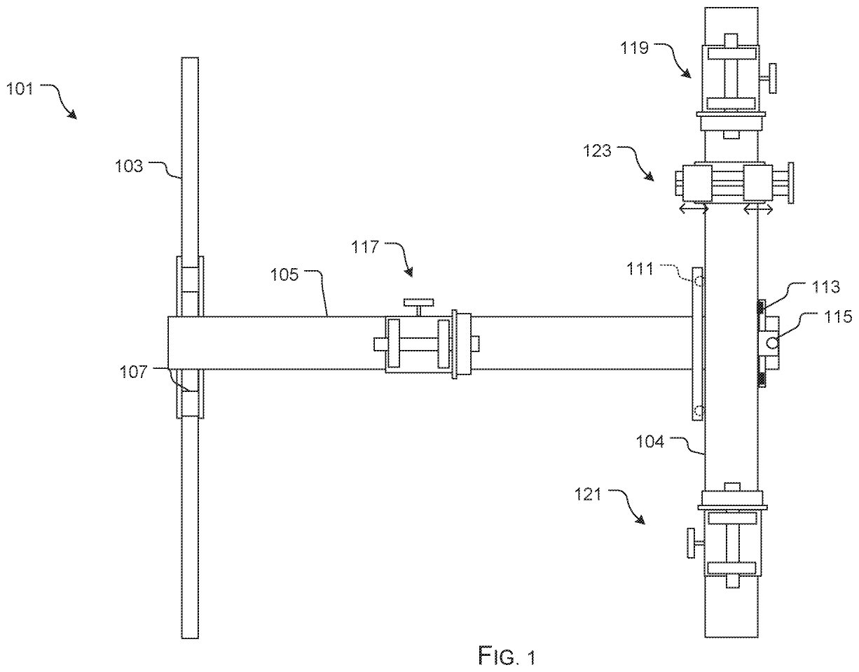

Referring now to the drawings wherein like reference characters identify corresponding or similar elements throughout the several views, FIG. 1 depicts a top view of a machine 101 in accordance with a preferred embodiment of the present application.

In the contemplated embodiment, machine 101 includes a support structure 103, 104 that can be made up of one or more I-beams. The support structure 103 can be mounted to a floor, a skid, or the like and can vary in size as needed. The machine 101 further includes one or more traveling beams 105 that can engage with the support structure via one or more rollers 107. It should be appreciated that the traveling beams 105 can be configured to move horizontally and/or vertically, thereby providing a means to adjust one or more pipes.

The one or more traveling beams can further engage with support structure 104 via one or more rollers 111, 113, and a clamping device 115 that secures the traveling beam 105 in a desired position.

The machine of the present invention further includes one or more carriages 117, 119, 121 and one or more custom vices 123.

It should be appreciated that one of the unique features believed characteristic of the present application is the combination of features that allow for pipes and fittings to be tacked together quickly and easily through a joining process. The system further allows for connection via any angle desired by the user.

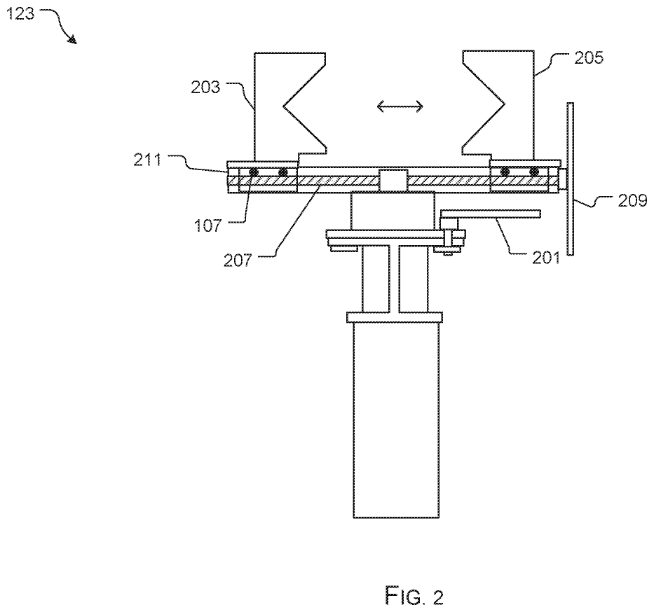

In FIG. 2, an end view of a custom vice 123 is shown. Custom vice 123 can include a cam locking device 201 configured to secure the apparatus in place in the desired position. The vice 123 can further include clamp jaws 203, 205 that are connected to a screw 207 that is engaged with a handle 209, wherein the handle can move the jaws together along a support 211. It should be appreciated that the vice can include any other features as are known in the art and configured to provide functionality to the vice. It should be appreciated that the jaws can vary in shape and size as needed.

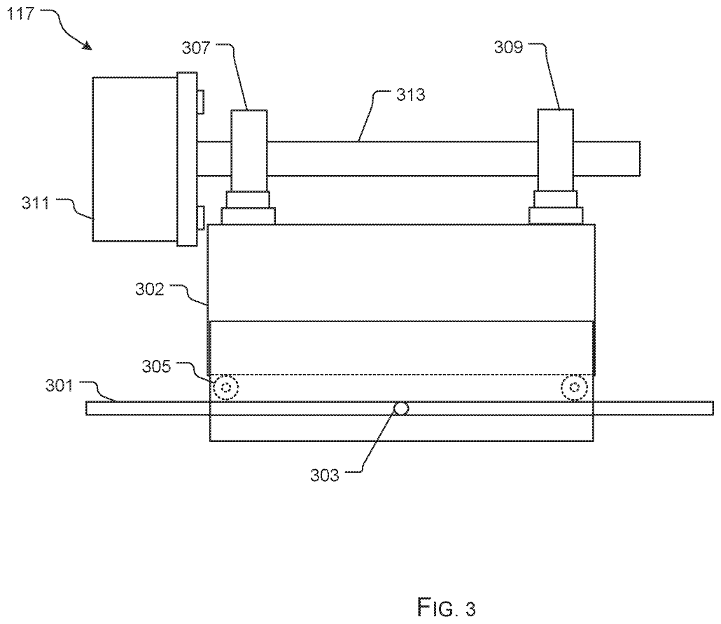

In FIG. 3, a side view depicts a carriage 117 contemplated for use in the present invention. The carriage 117 can secure to an I beam flange 301 via a support structure 302 and a threaded hole 303 configured to receive a locking device. The carriage 117 can be moveable via one or more cam follow rollers 305, thereby providing the user with versatility as desired and needed. The carriage 117 can further include one or more pillow blocks 307, 309 a chuck jaw 311 with a shaft 313 extending therebetween.

The system of the present invention can be modified and adapted as necessary to fit the needs of the user.

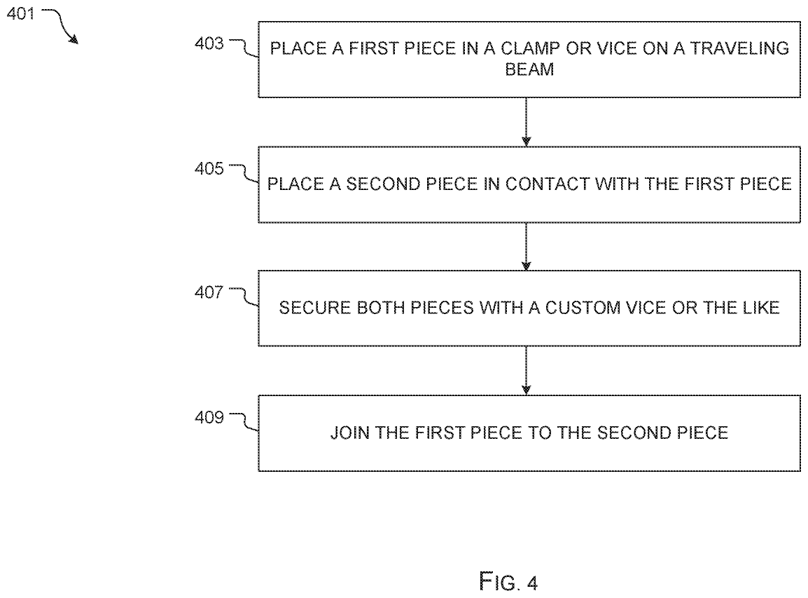

Referring now to FIG. 4 a method of joining pipe and fitting is depicted. Method 401 includes placing a first piece in a clamp or vice 403, placing a second piece in contact with the first piece 405, securing both pieces with a custom vice or the like 407 and joining the first piece to the second piece 409.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed;:

1. A machine comprising:
at least one support structure that has at least one traveling beam that moves over or interacts therewith via rollers;
at least one clamping device
at least one carriage; and
at least one custom vice;
wherein pipes and fittings are positioned thereby in preparation for joining processes; and
wherein the next arrangement of pipes or fittings is quickly produced.

2. The machine of claim 1 wherein the traveling beam moves horizontally or vertically.

3. The machine of claim 1 wherein the custom vice includes a cam locking device or clamp jaws.

4. A method of joining pipes and fittings, comprising:
placing a first piece in a clamp or vice on a traveling beam;
placing a second piece in contact with the first piece;
securing both pieces with a custom vice or the like; and
joining the first piece to the second piece.
